(19) United States
(12) Patent Application Publication
(10) Pub. No.: US 2004/0147651 A1
(43) Pub. Date: Jul. 29, 2004

(54) Polysulphide organosiloxanes which can be used as coupling agents, elastomer compositions containing same and elastomer articles prepared from said compositions

(76) Inventors: Pierre Barruel, Francheville (FR); Nathalie Guennouni, Irigny (FR)

Correspondence Address: BURNS DOANE SWECKER & MATHIS L L P, POST OFFICE BOX 1404, ALEXANDRIA, VA, 22313-1404, US

(21) Appl. No.: 10/474,747

(22) PCT Filed: Apr. 8, 2002
(86) PCT No.: PCT/FR02/01213

(30) Foreign Application Priority Data
Apr. 10, 2001 (FR) 01/04877

(51) Int. Cl. C08L 1/00

(52) U.S. Cl. 524/262; 524/493; 524/437; 524/571

(57) ABSTRACT

The invention relates to propylene articulated polysulphide monoorganoxysilanes of formula (I): wherein R¹, R² et R⁵ are monovalent hydrocarbon groups and x is a number ranging from 3±0.1 to 5±0.1 Said compounds can be used as white charge-elastomer coupling agents in dienic rubber compositions comprising a white charge such as a siliceous material as a reinforcing charge. The invention also relates to dienic elastomer compositions comprising at least one polysulphide silane of formula (I), and dienic elastomer articles prepared from said compositions.

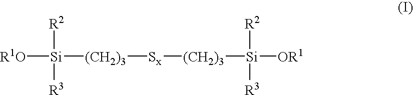

The present invention relates to novel polysulphide organoxysilanes, to the processes which allow them to be prepared and to their use as white filler-elastomer coupling agent in rubber compositions comprising a white filler, in particular a siliceous material, as reinforcing filler. The invention is also targeted at rubber compositions comprising such a coupling agent and at the articles based on one of these compositions.

The coupling agents of the invention are particularly useful in the preparation of articles made of elastomers subjected to various stresses, such as a temperature variation, a high-frequency loading variation under dynamic conditions, a high static stress or a high flexural fatigue under dynamic conditions. Examples of articles of this type are conveyor belts, power transmission belts, flexible pipes, expansion joints, seals for domestic electrical appliances, supports which act to remove engine vibrations, either with metal frameworks or with a hydraulic fluid within the elastomer, cables, cable sheathings, shoe soles and rollers for cableways.

Elastomer compositions appropriate for the preparation of such articles should exhibit the following properties:

rheological properties marked by viscosities which are as low as possible for great ease of processing of the raw blends prepared, in particular in extrusion and calendering operations;

vulcanization times which are as short as possible in order to achieve excellent productivity of the vulcanization plant;

excellent reinforcing properties conferred by a filler, in particular optimum values of tensile modulus of elasticity and of tensile strength.

To achieve such an objective, numerous solutions have been provided which have essentially concentrated on the use of elastomer(s) modified with a reinforcing filler. It is known, generally, that in order to obtain the optimum reinforcing properties conferred by a filler, it is advisable for the latter to be present in the elastomer matrix in a final form which is both as finely divided as possible and as homogeneously distributed as possible. In point of fact, such conditions can only be produced insofar as the filler exhibits a very good ability, first, to be incorporated in the matrix during the blending with the elastomer(s) and to deagglomerate and, secondly, to disperse homogeneously in the elastomer matrix.

It is known that carbon black is a filler which exhibits such abilities but that this is not generally the case for white fillers. The use of white reinforcing filler alone, in particular of reinforcing silica alone, has proved to be inappropriate due to the low level of certain properties of such compositions and consequently of certain properties of the articles in which these compositions are used. Because of mutual affinity, the particles of white filler, in particular of silica, have an unfortunate tendency to agglomerate with one another in the elastomer matrix. These filler/filler interactions have the harmful consequence of limiting the dispersion of the filler and therefore of limiting the reinforcing properties to a level substantially lower than that which it would be theoretically possible to reach if all the (white filler-elastomer) bonds capable of being created during the blending operation were actually obtained. Moreover, these interactions also tend to increase the viscosity in the raw state of the elastomer compositions and thus to make their use more difficult than in the presence of carbon black.

It is known to a person skilled in the art that it is necessary to use a coupling agent, also known as a binding agent, the role of which is to provide the connection between the surface of the particles of white filler and the elastomer, while facilitating the dispersion of this white filler within the elastomeric matrix.

The term “(white filler-elastomer) coupling agent” is understood to mean, in a known way, an agent capable of establishing a satisfactory connection, chemical and/or physical in nature, between the white filler and the elastomer; such a coupling agent, which is at least bifunctional, has, for example, as simplified general formula, “Y—B—X”, in which:

Y represents a functional group which is capable of physically and/or chemically bonding to the white filler, it being possible for such a bond to be established, for example, between a silicon atom of the coupling agent and the surface hydroxyl groups (OH) of the white filler (for example, surface silanols in the case of silica);

X represents a functional group capable of physically and/or chemically bonding-to the elastomer, for example via a sulphur atom;

B represents a hydrocarbonaceous group which makes it possible to connect Y and X.

The coupling agents must in particular not be confused with the simple white filler coating agents which, in a known way, can comprise the Y functional group, active with respect to the white filler, but are devoid of the X functional group, active with respect to the elastomer.

Coupling agents, in particular silica-elastomer coupling agents, have been described in a great many documents, the best known being bifunctional organoxysilanes carrying at least one organoxysilyl functional group as Y functional group and, as X functional group, at least one functional group capable of reacting with the elastomer, such as, in particular, a polysulphide functional group.

Thus, provision has been made for the use, as polysulphide organoxysilanes, of polysulphide alkoxysilanes, in particular bis (tri (C₁-C₄) alkoxylsilylpropyl) polysulphides as disclosed in numerous patents or patent applications (see, for example, FR-A-2 149 339, FR-A-2 206 330, U.S. Pat. No. 3,842,111, U.S. Pat. No. 3,873,489, U.S. Pat. No. 3,997,581). Mention will in particular be made, among these polysulphides, of bis(triethoxysilylpropyl) tetrasulphide (abbreviated to TESPT), which is generally regarded today as the product introducing, for vulcanisates comprising silica as filler, the best compromise in terms of security from scorching, of ease of processing and of reinforcing power but which has the known disadvantage of being very expensive and of generally having to be used in relatively large amounts (see, for example, U.S. Pat. No. 5,652,310, U.S. Pat. No. 5,684,171, U.S. Pat. No. 5,684,172).

During the preparation of rubber compositions comprising particles of reinforcing white filler and a coupling agent of polysulphide organoxysilane type, there occurs, during all or part of the preparation stages well known to a person skilled in the art, for example during the stage of mixing in a conventional internal mixer, a chemical reaction involving the organoxy part of the silane and the surface OH groups of the white filler, for example the surface silanols in the case of silica. As is described in the literature [cf. A. Hunsche et al., Kautschuk Gummi, Kunststoffe, 80, 881 (1997) and Kautschuk Gummi, Kunststoffe, No. 7-8, 525 (1998)], in the case of silica and TESPT, this chemical reaction is a condensation reaction which is accompanied by significant evolution of ethanol; more specifically, this chemical reaction makes it possible, when organoxysilanes, such as TESPT, carrying three ethoxy functional groups bonded to the silicon are used, to release up to three mol of ethanol per mole of silane. This released alcohol is the cause of technical problems during the subsequent conversion of the rubber compositions, marked by the appearance of an undesirable porosity during, for example, extrusion of the compositions and/or the undesirable formation of bubbles in the rubber itself. Furthermore, a reduction in the evolution of alcohol is also desirable for ecological and health reasons.

Provision has been made, in EP-A-1 043 357, to reduce the evolution of alcohol by the use of a polysulphide organoxysilane coupling agent for which the number of organoxy functional groups, such as, for example, ethoxy functional groups, carried by the silicon is reduced with respect to the coupling agents conventionally used, such as TESPT (carrier of three ethoxy functional groups), and is preferably chosen equal to one organoxy functional group.

Examples given in this prior art illustrate disulphide organoxysilanes where the organoxysilyl and disulphide groups are connected to one another via a divalent propylene linking unit and make it possible to compare the behaviour of bis(monoethoxydimethylsilylpropyl) disulphide (abbreviated to MESPD; Example 2 according to the invention) with that of bis(triethoxysilylpropyl) disulphide (abbreviated to TESPD; Example 1, control); the results obtained show that the rubber composition using MESPD releases an amount of ethanol which is reduced by 66% and results in a vulcanizate with mechanical properties which are not weakened with respect to that which transpires with the control TESPD.

However, it is noticed that, in the comparison made in EP-A-1 043 357 between the compositions of Examples 1 and 2, the vulcanization conditions are very different: the vulcanization time at 165° C. is 16 minutes for the control Example 1 using TESPD, whereas it is 30 minutes for Example 2 according to the invention using MESPD. In point of fact, according to the information available to him, a person skilled in the art knows that the vulcanization time can have an effect on the mechanical properties of vulcanizates. On repeating the experiments of Examples 1 and 2 of EP-A-1 043 357 under the same conditions of temperature and of vulcanization time (that is to say, 165° C. and 30 minutes), the Applicant Company found that the replacement of the triethoxy coupling agent used in control Example 1 (TESPD) by the monoethoxy compound used in Example 2 (MESPD), while it indeed makes it possible to reduce the amount of alcohol released, on the other hand, in contradiction to that which emerges from the examples of EP-A-1 043 357, results in a significant weakening of some of the mechanical properties of the vulcanizates and in particular the moduli at high elongations, the tensile strength and the reinforcement index (ratio of a modulus at high elongation of 300% to a modulus at high elongation of 100%; this reinforcement index is correlated with the effectiveness of the coupling of the white filler to the elastomer).

The Applicant Company has continued its studies in this field of technology and has now found, which constitutes one of the subject matters of the present invention, that coupling agents based on monoorganoxyl and tetrasulphide silanes with a propylene linking unit, which are higher homologues, with regard to the polysulphide group, of the monoorganoxyl and disulphide silanes with a propylene linking unit illustrated in EP-A-1 043 357, and in particular bis(monoethoxydimethylsilylpropyl) tetrasulphide (abbreviated to MESPT):

not only do not exhibit the disadvantages marked by a weakening in the mechanical properties considered above when they are compared, under the same vulcanization conditions, with the corresponding triorganoxyl coupling agents and in particular TESPT,

but also make it possible to achieve, when they are compared, under the same vulcanization conditions, with the corresponding monoorganoxyl and disulphide lower homologue silanes and in particular MESPD: for the compositions in the raw state: a lower minimum torque, a higher maximum torque and a higher delta torque, and faster kinetics of vulcanization; and for the vulcanizates: levels of moduli at high elongations, of tensile strength, of reinforcement index (optionally) and of hardness (Shore or other) which are also higher; which, overall, constitutes, for tetrasulphide monoorganoxysilanes with a propylene linking unit, a more advantageous compromise in Theological and mechanical properties than that obtained for disulphide monoorganoxysilanes with a propylene linking unit.

### FIRST SUBJECT MATTER OF THE INVENTION

Consequently, a first subject matter of the invention relates, as novel products, to polysulphide monoorganoxysilanes with a propylene linking unit of formula:

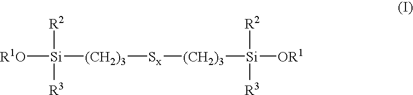

in which:

the R¹ symbols, which are identical or different, each represent a monovalent hydrocarbonaceous group chosen from a linear or branched alkyl radical having from 1 to 4 carbon atoms and a linear or branched alkoxyalkyl radical having from 2 to 8 carbon atoms;

the R² and R³ symbols, which are identical or different, each represent a monbvalent hydrocarbonaceous group chosen from a linear or branched alkyl radical having from 1 to 6 carbon atoms and a phenyl radical; and

x is an integer or fractional number ranging from 3±0.1 to 5±0.1.

In the preceding formula (I) the preferred R¹ radicals are chosen from the radicals: methyl, ethyl, n-propyl, isopropyl, n-butyl, CH₃OCH₂—, CH₃OCH₂CH₂— and CH₃OCH(CH₃)CH₂—; more preferably, the R¹ radicals are chosen from the radicals: methyl, ethyl, n-propyl and isopropyl.

The preferred R² and R³ radicals are chosen from the radicals: methyl, ethyl, n-propyl, isopropyl, n-butyl, n-hexyl and phenyl; more preferably, the R² and R³ radicals are methyls.

The integer or fractional number x preferably ranges from 3.5±0.1 to 4.5±0.1 and more preferably from 3.8±0.1 to 4.2±0.1.

The polysulphide monoorganoxysilanes corresponding to the formula (I) which are especially targeted by the present invention are those of formula:

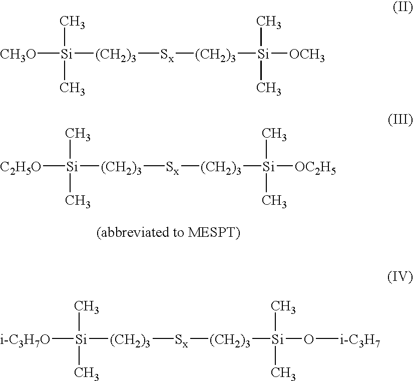

in which the x symbol is an integer or fractional number ranging from 3±0.1 to 5±0.1, preferably from 3.5±0.1 to 4.5±0.1 and more preferably from 3.8±0.1 to 4.2±0.1.

In the present report, it will be specified that the symbol x in the formulae (I), (II), (III) and (IV) is an integer or fractional number which represents the number of sulphur atoms present in a molecule of formula (I), (II), (III) and (IV).

This number can be an exact number of sulphur atoms in the case where the synthetic route to the compound under consideration can give rise only to a single kind of polysulphide product.

However, in practice, this number is the mean of the number of sulphur atoms per molecule of compound under consideration, insofar as the chosen synthetic route gives rise instead to a mixture of polysulphide products each having a different number of sulphur atoms. In this case, the polysulphide monoorganoxysilanes synthesized are in fact composed of a distribution of polysulphides, ranging from the disulphide S₂ to heavier polysulphides S_{≧5}, centred on a mean value in moles (value of the x symbol) lying within the general range (x ranging from 3±0.1 to 5±0.1), preferential range (x ranging from 3.5±0.1 to 4.5±0.1) and more preferable range (x ranging from 3.8±0.1 to 4.2±0.1) which are mentioned above. Advantageously, the polysulphide monoorganoxysilanes synthesized are composed of a distribution of polysulphides comprising a molar level: of (S₃+S₄), equal to or greater than 40% and preferably equal to or greater than 50%; and of (S₂+S_{≧5}), equal to or less than 60% and preferably equal to or less than 50%. Furthermore, the molar level of S₂ is advantageously equal to or less than 30% and preferably equal to or less than 20%. All the limit values are given to within the accuracy of measurement (by NMR), with an absolute error of approximately ±1.5 (for example 20±1.5% for the last level indicated).

### SECOND SUBJECT MATTER OF THE INVENTION

The polysulphide monoorganoxysilanes of the formula (I), (II), (III) or (IV) can be obtained, which constitutes the second subject matter of the present invention, by employing one or other of the following methods or related methods.

Method A

The compounds of formula (I), (II), (III) or (IV) can be obtained by direct reaction of a halogenated monoorganoxysilane of formula (V) with an anhydrous metal polysulphide of formula (VI), the reaction being carried out at a temperature ranging from −20° C. to 90° C., optionally in the presence of an inert polar (or nonpolar) organic solvent, by applying the following synthetic scheme:

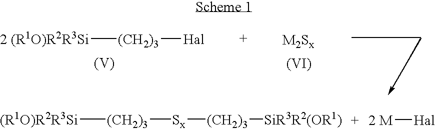

where:

the R¹, R², R³ and x symbols are as defined above in the first subject matter of the invention;

the Hal symbol represents a halogen atom chosen from chlorine, bromine and iodine atoms and preferably represents a chlorine atom;

the M symbol represents an alkali metal or alkaline earth metal and preferably represents an alkali metal chosen from lithium, sodium and potassium.

As regards the practical way of carrying out the abovementioned synthesis, reference may be made, for further details, to the content of EP-A-0 848 006, which illustrates, starting from other reactants, procedures which can be applied to the implementation of the synthesis under consideration; the content of this EP application is furthermore incorporated in full in the present account by reference.

The halogenated silanes of formula (V) are commercial products or products which can easily be prepared from commercial products. The metal polysulphides of formula (VI) can be prepared, for example, by reaction of an alkaline sulphide M₂S, comprising water of crystallization, with elemental sulphur, the reaction being carried out at a temperature ranging from 60° C. to 300° C. under vacuum and in the absence of an organic solvent.

Method B

The compounds of formula (I), (II), (III) or (IV) can also be obtained by direct reaction of elemental sulphur with a monoorganoxysilanethiol of formula (VII), the reaction being carried out at a temperature ranging from 10° C. to 250° C., optionally in the presence of an inert polar (or nonpolar) organic solvent, by applying the following synthetic scheme:

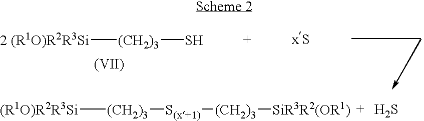

where:

the R¹, R² and R³ symbols are as defined above in method A;

x′ is an integer or fractional number ranging from 2±0.1 to 4±0.1, preferably from 2.5±0.1 to 3.5±0.1, and more preferably from 3.8±0.1 to 4.2±0.1.

As regards the practical way of carrying out the abovementioned synthesis, reference may-be made, for further details, to the content of FR-A-2 260 585, which illustrates, starting from other reactants, procedures which can be applied to the implementation of the synthesis under consideration; the content of this FR application is itself also included in the present application by reference.

The silanethiols of formula (VII) are commercial products or products which can be easily prepared from commercial products.

Method C

The compounds of formula (I), (II), (III) or (IV) can also be obtained by direct reaction of elemental sulphur and of an alkali metal M′ with a halogenated silane of formula (V), the reaction being carried out at a temperature ranging from 60° C. to 100° C., optionally in the presence of an aprotic organic solvent, by applying the following synthetic scheme:

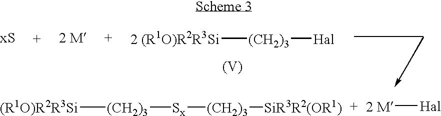

where:

the R¹, R², R³, x and Hal symbols are as defined above in method A;

the M′ symbol represents an alkali metal and preferably lithium, sodium or potassium.

As regards the practical manner of carrying out the abovementioned synthesis, reference may be made, for further details, to the content of U.S. Pat. No. 6,066,752, which illustrates, starting from other reactants, procedures which can be applied to the implementation of the synthesis under consideration; the content of this U.S. patent is itself also incorporated in full in the present account by reference.

Method D

The compounds of formula (I), (II), (III) or (IV) can also be obtained, and this is a process which is preferably used in the context of the second subject matter of the present invention, by carrying out the following stages (a) and (b):

(a) H₂S is brought into contact with a metal alkoxide of formula (VIII), employed in the solution form, the reaction being carried out at a temperature ranging from 25° C. to 60° C., optionally in the presence of an inert polar (or nonpolar) organic solvent, by applying the following synthetic scheme:

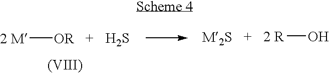

where M′ is as defined above in method C and R represents a linear or branched alkyl radical having from 1 to 4 carbon atoms and preferably represents an ethyl radical; then

(b) a mixture based on elemental sulphur and on halogenated monoorganoxysilane of formula (V) defined above in method A is reacted with the reaction product from stage (a), the reaction being carried out at a temperature ranging from 25° C. to the reflux temperature of the reaction medium.

As regards the practical way of carrying out the abovementioned stages (a) and (b), reference may be made, for further details, to the content of U.S. Pat. No. 5,489,701, which illustrates, starting from other reactants, procedures which can be applied to the implementation of the synthesis under consideration; the content of this U.S. patent is itself also incorporated in full in the present account by reference.

Method E

The compounds of formula (I), (II), (III) or (IV) can also be obtained, and this is another process which is preferably used in the context of the second subject matter of the present invention, by carrying out stages (c) and (d) defined below:

(c) ammonia NH₃ or an amine is brought into contact, at ambient temperature of the order of 25° C., with H₂S and elemental sulphur; then

(d) the halogenated silane of formula (V) defined above in method A is reacted with the reaction product from stage (c), the reaction being carried out under autogenous pressure at a temperature ranging from 0° C. to 175° C., optionally in the presence of an inert polar (or nonpolar) organic solvent, by applying the following synthetic scheme:

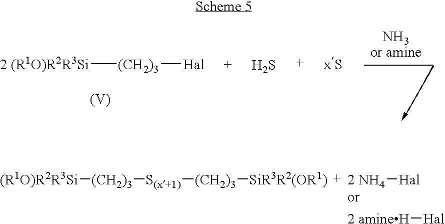

where the various R¹, R², R³, Hal and x′ symbols are as defined above in methods A and B (for the x′ symbol).

As regards the practical way of carrying out the abovementioned stages (c) and (d), reference may be made, for further details, to the content of U.S. Pat. No. 4,125,552, which illustrates, starting from other reactants, procedures which can be applied to the implementation of the synthesis under consideration; the content of this U.S. patent is itself also incorporated in full in the present account by reference.

It should be noted that, during the implementation of the abovementioned stage (c), the compound of formula (IX) (NH₄)₂S_{(x′+1}) or (X) (amine)₂S_{(x′+1}) is formed in situ, which compound is in fact the active principle which will give rise, by reaction with the halogenated silane of formula (V), to the polysulphide monoorganoxysilane in particular of formula (I).

Method F

The compounds of formula (I), (II), (III) or (IV) can also be obtained, and this is another process which is preferably used in the context of the second subject matter of the present invention, by carrying out stages (e) and (f) defined below:

(e) a metal alkoxide of formula (VIII) defined above in method D, employed in the solution form, is brought into contact, at a temperature ranging from 25° C. to 80° C., optionally in the presence of an inert polar (or nonpolar) organic solvent, with, in a first step, elemental sulphur and, in a second step, H₂S; then

(f) the halogenated silane of formula (V) defined above in method A is reacted with the reaction product from stage (e), the reaction being carried out at a temperature ranging from 40° C. to 100° C., optionally under autogenous pressure, optionally in the presence of an inert polar (or nonpolar) organic solvent;

by applying the following synthetic scheme:

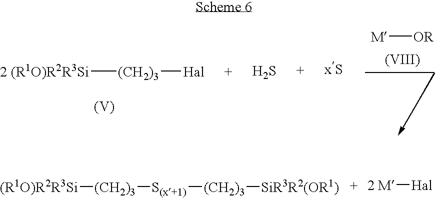

where the various R¹, R², R³, Hal, x′, M′ and R symbols are as defined above in methods A and B (for x′) and D (for M′ and R).

As regards the practical way of carrying out the abovementioned stages (e) and (f), reference may be made, for further details, to the content of U.S. Pat. No. 4,125,552, which illustrates, starting from other reactants and by employing an amino base instead of a metal alkoxide base, procedures which can be applied to the implementation of the synthesis under consideration.

It should be noted that, during the implementation of the abovementioned stage (e), the compound of formula (XI) M′₂S_{(x′+1)} is formed in situ, which compound is, in fact, the active principle which will give rise, by reaction with the halogenated silane of formula (V), to the polysulphide monoorganoxysilane in particular of formula (I).

Preferably, the abovementioned stage (e) is carried out by preparing the metal alkoxide+sulphur+H₂S mixture at a temperature ranging from 20° C. to 25° C. and by then subsequently heating the mixture to a temperature ranging from 50° C. to 80° C. for a period of time ranging from 30 minutes to 2 hours, so as to bring to completion the formation of the compound of formula (XI); subsequently, the reaction medium is cooled to a temperature ranging from 15° C. to 25° C. before beginning the procedure of stage (f).

With respect to the amounts of reactants, there must be at least two mol of halogenated silane (V) per mole of H₂S and at least two mol of S per mole of H₂S. The number of elemental sulphur atoms S_{(x′+1)} in the polysulphide group depends on the molar ratio of S with respect to H₂S. For example, the use of three mol of S (x′=3) per mole of H₂S gives the tetrasulphide (x′+1=4).

The method F which has just been described is novel in itself and it will constitute another aspect of the present invention, taken in its second subject matter. This method can advantageously be used for the preparation of other polysulphide silanes than the polysulphide monoorganoxysilanes with a propylene linking unit in particular of formula (I) according to the invention.

Thus it is that the said method F, which, in what follows, will take the name method F′, can advantageously be used in the preparation of polysulphide silanes of formula:

(R¹O)ₐ(R²)_{b}(R³)_{c}Si—R⁴—S_{y}—R⁴—Si(R³)_{c}(R²)_{b}(OR¹)ₐ (XII)

in which:

the R¹, R² and R³ symbols are as defined above with respect to the formula (I) given in the first subject matter of the invention;

the a, b and c symbols each represent an integer ranging from 0 to 3, the sum a+b+c having to be equal to 3;

the R⁴ symbols, which are identical or different, each represent a divalent radical chosen from: a linear or branched divalent alkylene radical having from 1 to 18 carbon atoms; an -alkylene-cycloalkylene-radical where the alkylene part is as defined immediately above and where the cyclic part comprises 5 to 10 carbon atoms and is optionally substituted by one or two linear or branched alkyl radicals having from 1 to 3 carbon atoms; a divalent -alkylene-phenylene-(alkylene)_{z}- radical where z=0 or 1, where the alkylene part(s) is (are) as defined immediately above and where the phenylene part is optionally substituted by one or two linear or branched alkyl radicals having from 1 to 3 carbon atoms;

the y symbol represents an integer or fractional number ranging from 2±0.1 to 10±0.1;

it being clearly understood that the polysulphide organoxysilanes corresponding to the formula (I), that is to say the polysulphide silanes of formula (XII) where cumulatively a=b=c=1, R⁴=—(CH₂)₃— and y is a number ranging from 3±0.1 to 5±0.1, are excluded from the formula (XII).

Preferably, the R⁴ symbol can represent an alkylene radical which corresponds to the following formulae:

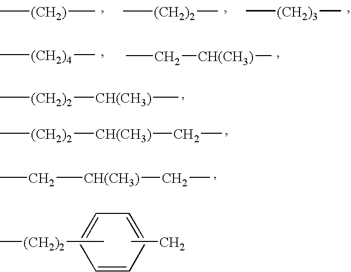

In the same way, method F′ clearly applies, for example, to the preparation:

of the silane MESPD of formula:

(C₂H₅O)(CH₃)₂Si—(CH₂)₃—S₂—(CH₂)₃—Si(CH₃)₂(OC₂H₅)

of bis(monoethoxydimethylsilylmethyl) disulphide of formula:

(C₂H₅O)(CH₃)₂Si—CH₂—S₂—CH₂—Si(CH₃)₂(OC₂H₅).

The compounds of formula (XII) can therefore be obtained by employing stages (e′) and (f′) defined below:

(e′) a metal alkoxide of formula (VIII) defined above in method D, employed in the solution form, is brought into contact, at a temperature ranging from 25° C. to 80° C., optionally in the presence of an inert polar (or nonpolar) organic solvent, with, in a first step, elemental sulphur and, in a second step, H₂S; then

(f′) the halogenated silane of formula (XIII) is reacted with the reaction product from stage (e′), the reaction being carried out at a temperature ranging from 40° C. to 100° C., optionally under autogenous pressure, optionally in the presence of an inert polar (or nonpolar) organic solvent;

by applying the following synthetic scheme:

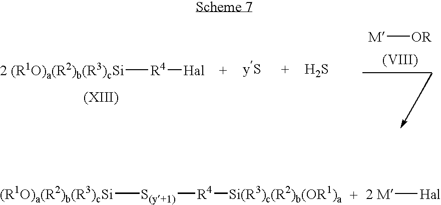

where:

the R¹, R², R³, R⁴, a, b and c symbols are as defined above in the formrula (XII);

the Hal symbol is as defined above in method A; and the formula (VIII) is as defined above in method D;

the y′ symbol is an integer or fractional number ranging from 1 to 9.

It will be specified that the y symbol of the formula (XII) and the sums (x′+1) of the formulae of the polysulphide monoorganoxysilanes of schemes 2, 5 and 6 and (y′+1) of the formula of the polysulphide silane of scheme 7 are integers or fractional numbers which represent the number of sulphur atoms present in a molecule with the formula under consideration; this number can be an exact number of sulphur atoms in the case where the synthetic route to the compound under consideration can only give rise to a single kind of polysulphide product; however, in practice, this number is the mean of the number of sulphur atoms per molecule of the compound under consideration, insofar as the chosen synthetic route gives rise instead to a mixture of polysulphide products, each having a different number of sulphur atoms.

### THIRD SUBJECT MATTER OF THE INVENTION

According to another of its subject matters, the present invention relates to the use of an effective amount of at least one polysulphide monoorganoxysilane with a propylene linking unit of formula (I), (II), (III) or (IV) as white filler-elastomer coupling agent in compositions comprising at least one diene elastomer and one white filler as reinforcing filler, the said compositions being intended for the manufacture of articles made of diene elastomer(s).

The coupling agents which are preferably used are composed of the polysulphide monoorganoxysilanes of formula (I) in which the various R¹, R², R³ and x symbols have the preferred definitions indicated above in the context of the first subject matter of the invention. The coupling agents which are more preferably used are composed of the polysulphide monoorganoxysilanes of formula (I) in which the various R¹, R², R³ and x symbols have the more preferred definitions indicated above in the context of the first subject matter of the invention. The coupling agents which are especially well suited are composed of the polysulphide monoorganoxysilanes of formula (II), (III) or (IV).

### FOURTH SUBJECT MATTER OF THE INVENTION

In the context of this coupling agent application, the present invention also relates to, in a fourth subject matter, the diene elastomer compositions comprising a reinforcing white filler obtained by virtue of the use of an effective amount of at least one polysulphide monoorganoxysilane with a propylene linking unit of formula (I), (II), (III) or (IV).

More specifically, these compositions comprise (the parts are given by weight):

per 100 parts of diene elastomer(s),

10 to 200 parts of reinforcing white filler, preferably 20 to 150 and more preferably still 30 to 100 parts,

1 to 20 parts, preferably 2 to 20 parts and more preferably still 2 to 12 parts of coupling agent(s).

Advantageously, the amount of coupling agent(s), chosen within the abovementioned general and preferred regions, is determined so that it represents from 0.5% to 20%, preferably from 1% to 15% and more preferably from 1% to 10%, with respect to the weight of the reinforcing white filler.

A person skilled in the art will understand that the coupling agent might be grafted beforehand to the reinforcing white filler (via its alkoxysilyl, in particular ethoxysilyl, functional group), it being possible for the white filler, thus “precoupled”, to be subsequently bonded to the diene elastomer via the polysulphide free functional group.

In the present report, the expression “reinforcing white filler” is understood to define a white filler capable of reinforcing, by itself alone, without means other than that of a coupling agent, a natural or synthetic elastomer composition of rubber type.

The physical state under which the reinforcing white filler exists is not important, that is to say that the said filler can exist in the form of a powder, micropearls, granules or beads.

Preferably, the reinforcing white filler is composed of silica, alumina or a mixture of these two entities.

More preferably, the reinforcing white filler is composed of silica, taken alone or as a mixture with alumina.

Any precipitated or pyrogenic silica known to a person skilled in the art exhibiting a BET specific surface area ≦450 m²/g is suitable as silica capable of being employed in the invention. Preference is given to precipitated silicas, it being possible for these to be conventional or highly dispersible.

The term “highly dispersible silica” is understood to mean any silica having a very high ability, observable by electron or optical microscopy on thin sections, to deagglomerate or to disperse in a polymer matrix. Mention may be made, as nonlimiting examples of highly dispersible silicas, of those having a CTAB specific surface area of equal to or less than 450 m²/g, preferably ranging from 30 to 400 m²/g, and particularly those disclosed in U.S. Pat. No. 5,403,570 and Patent Applications WO-A-95/09127 and WO-A-95/09128, the contents of which are incorporated here. Mention may be made, as nonlimiting examples of such preferred highly dispersible silicas, of Perkasil KS 43.0 silica from Akzo, BV3380 silica from Degussa, Zeosil 1165 MP and 1115 MP silicas from Rhodia, Hi-Sil 2000 silica from PPG, or Zeopol 8741 or 8745 silicas from Huber. Treated precipitated silicas, such as, for example, the silicas “doped” with aluminium disclosed in Patent Application EP-A-0 735 088, the content of which is also incorporated here, are also suitable.

More preferably, the precipitated silicas having:

a CTAB specific surface area ranging from 100 to 240 m²/g, preferably from 100 to 180 m²/g,

a BET specific surface area ranging from 100 to 250 m²/g, preferably from 100 to 190 m²/g,

a DOP oil uptake of less than 300 ml/100 g, preferably ranging from 200 to 295 ml/100 g,

a BET specific [lacuna]/CTAB specific surface area ratio ranging from 1.0 to 1.6,

are highly suitable.

Of course, the term “silica” is also understood to mean blends of different silicas. The CTAB specific surface area is determined according to the NFT 45007 method of November 1987. The BET specific surface area is determined according to the Brunauer, Emmett and Teller method described in “The Journal of the American Chemical Society, Vol. 60, page 309 (1938)”, corresponding to the NFT 45007 standard of November 1987. The DOP oil uptake is determined according to the NFT 30-022 standard (March 1953), employing dioctyl phthalate.

Use is advantageously made, as reinforcing alumina, of a highly dispersible alumina having:

a BET specific surface area ranging from 30 to 400 m²/g, preferably from 60 to 250 m²/g,

a mean particle size at most equal to 500 nm, preferably at most equal to 200 nm, and

a high level of reactive surface Al—OH functional groups,

as disclosed in the document EP-A-0 810 258.

Mention will in particular be made, as nonlimiting examples of similar reinforcing aluminas, of A125, CR125 and D65CR alumina from Baïkowski.

Diene elastomers capable of being employed for the compositions in accordance with the fourth subject matter of the invention is understood to mean more specifically:

(1) homopolymers obtained by polymerization of a conjugated diene monomer having from 4 to 22 carbon atoms, such as, for example: 1,3-butadiene, 2-methyl-1,3-butadiene, 2,3-dimethyl-1,3-butadiene, 2,3-diethyl-1,3-butadiene, 2-methyl-3-ethyl-1,3-butadiene, 2-chloro-1,3-butadiene, 2-methyl-3-isopropyl-1, 3-butadiene, 1-phenyl-1,3-butadiene, 1,3-pentadiene or 2,4-hexadiene;

(2) copolymers obtained by copolymerization of at least two of the abovementioned conjugated dienes with one another or by copolymerization of one or more of the abovementioned conjugated dienes with one or more ethylenically unsaturated monomers chosen from:

vinylaromatic monomers having from 8 to 20 carbon atoms, such as, for example: styrene, ortho-, meta- or para-methylstyrene, the “vinyl-toluene” commercial mixture, para-tert-butylstyrene, methoxystyrenes, chlorostyrenes, vinylmesitylene, divinylbenzene or vinylnaphthalene;

vinyl nitrile monomers having from 3 to 12 carbon atoms, such as, for example, acrylonitrile or methacrylonitrile;.

acrylic ester monomers derived from acrylic acid or from methacrylic acid with alkanols having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate;

the copolymers can comprise between 99% and 20% by weight of diene units and between 1% and 80% by weight of vinylaromatic, vinyl nitrile and/or acrylic ester units;

(3) ternary copolymers obtained by copolymerization of ethylene and of an α-olefin having 3 to 6 carbon atoms with a nonconjugated diene monomer having from 6 to 12 carbon atoms, such as, for example, the elastomers obtained from ethylene and propylene with a nonconjugated diene monomer of the abovementioned type, such as, in particular, 1,4-hexadiene, ethylidenenorbornene or dicyclopentadiene (EPDM elastomer);

(4) natural rubber;

(5) copolymers obtained by copolymerization of isobutene and of isoprene (butyl rubber), and the halogenated, in particular chlorinated or brominated, versions of these copolymers;

(6) a blend of several of the abovementioned elastomers (1) to (5) with one another.

Use is preferably made of one or more elastomer(s) chosen from: (1) polybutadiene, polychloroprene or polyisoprene [or poly(2-methyl-1,3-butadiene)]; (2) poly(isoprene-butadiene), poly(isoprene-styrene), poly(isoprene-butadiene-styrene), poly(butadiene-styrene) or poly(butadiene-acrylonitrile); (4) natural rubber; (5) butyl rubber;

(6) a blend of the abovementioned elastomers, in particular (1), (2), (4), (5), with one another; (6′) a blend comprising a predominant amount (ranging from 51% to 99.5% and preferably from 70% to 99% by weight) of polyisoprene (1) and/or of natural rubber (4) and a minor amount (ranging from 49% to 0.5% and preferably from 30% to 1% by weight) of polybutadiene, of polychloroprene, of poly(butadiene-styrene) and/or of poly(butadiene-acrylonitrile).

The compositions in accordance with the invention additionally comprise all or some of the other auxiliary additives and constituents conventionally used in the field of elastomer and rubber compositions.

Thus, use may be made of all or some of the other constituents and additives which follow: e mention will be made, regarding the vulcanization system, of, for example:

vulcanization agents chosen from sulphur or sulphur-donating compounds, such as, for example, thiuram derivatives;

vulcanization accelerators, such as, for example, guanidine derivatives or thiazole derivatives;

vulcanization activators, such as, for example, zinc oxide, stearic acid and zinc stearate;

mention will be made, regarding other additive(s), of, for example:

a conventional reinforcing filler composed of carbon black; any carbon black, in particular blacks of the HAF, ISAF or SAF type, is suitable as carbon black; mention may be made, as nonlimiting examples of such blacks, of N115, N134, N234, N339, N347 and N375 blacks; the amount of carbon black is determined so that, first, the reinforcing white filler employed represents more than 50% of the weight of the combined white filler+carbon black and, secondly, the total amount of reinforcing filler (white filler+carbon black) remains within the ranges of values indicated above for the reinforcing white filler with respect to the makeup by weight of the composition;

a conventional white filler with little or no reinforcing effect, such as, for example, clays, bentonite, talc, chalk, kaolin, titanium dioxide or a mixture of these entities;

antioxidants;

antiozonants, such as, for example, N-phenyl-N′-(1,3-dimethylbutyl)-p-phenylenediamine;

plasticizing agents and processing aids.

As regards the processing aids, the compositions in accordance with the invention can comprise agents for coating the reinforcing filler, for example comprising a single Y functional group, capable, in a known way, by virtue of an improvement in the dispersion of the filler in the rubber matrix and of a lowering in the viscosity of the compositions, of improving the ease of processing of the compositions in the raw state. Such agents are composed, for example, of alkylakoxysilanes (in particular alkyltriethoxysilanes), polyols, polyethers (for example, polyethylene glycols), primary, secondary or tertiary amines (for example, trialkanolamines), and α,ω-dihydroxylated polydimethylsiloxanes. Such a processing aid, when one of them is used, is employed in a proportion of 1 to 10 parts by weight, and preferably 2 to 8 parts, per 100 parts of reinforcing white filler.

The process for the preparation of the diene elastomer compositions comprising a reinforcing white filler and at least one coupling agent can be carried out according to a conventional one- or two-stage procedure.

According to the one-stage process, all the necessary constituents, with the exception of the vulcanization agent(s) and optionally of the vulcanization accelerator(s) and/or of the vulcanization activator(s), are introduced into and are mixed in a conventional internal mixer, for example of Banbury type or of Brabender type. The result of this first mixing stage is subsequently taken up on an external mixer, generally a multi-roll mixer, and then the vulcanization agent(s) and, optionally, the vulcanization accelerator(s) and/or the vulcanization activator(s) are added thereto.

It can be advantageous, for the preparation of some articles, to employ a two-stage process in which both stages are carried out in an internal mixer. In the first stage, either all the necessary constituents, with the exclusion of the vulcanization agent(s) and optionally of the vulcanization accelerator(s) and/or of the vulcanization activator(s), or a portion of the necessary constituents, applying the same exclusion rule, are introduced and mixed. The aim of the second stage which follows is essentially to subject the blend of the first stage, optionally completed by the addition of the necessary missing constituent(s) with application of the same exclusion rule, to an additional heat treatment. The result of this second stage is also subsequently taken up on an external mixer in order to add thereto the vulcanization agent(s) and optionally the vulcanization accelerator(s) and/or the vulcanization activator(s).

The phase of operating in an internal mixer is generally carried out at a temperature ranging from 80° C. to 200° C., preferably from 80° C. to 180° C. This first operating phase is followed by the second operating phase in an external mixer at a lower temperature, generally below 120° C. and preferably ranging from 20° C. to 80° C.

The final composition obtained is subsequently calendered, for example in the form of a sheet, of a panel or of a section which can be used for the manufacture of articles made of elastomer(s).

The vulcanization (or curing) is carried out in a known way at a temperature generally ranging from 130° C. to 200° C., optionally under pressure, for a sufficient time which can vary, for example, between 5 and 90 minutes according in particular to the curing temperature, the vulcanization system adopted and the kinetics of vulcanization of the composition under consideration.

It is obvious that the present invention, taken in its fourth subject matter, relates to the elastomer composition described above both in the raw state (i.e., before curing) and in the cured state (i.e. after crosslinking or vulcanization).

### FIFTH SUBJECT MATTER OF THE INVENTION

The elastomer compositions will be used to prepare articles made of elastomer(s) having a body comprising the said compositions described above in the context of the fourth subject matter of the invention. These compositions are particularly useful for preparing articles composed of engine supports, shoe soles, cableway rollers, seals for domestic electrical appliances, and cable sheathings.

The following examples illustrate the present invention.

Analyses by ²⁹Si NMR, ¹H NMR and ¹³C NMR are carried out under the following conditions:

²⁹Si NMR

Equipment

One-dimensional silicon-29 NMR analyses were carried out with a Bruker AMX 300 spectrometer and a selective ²⁹Si 10 mm probe operating with a silicon observation frequency at 59 MHz.

The chemical shifts (δ) are expressed in ppm and tetramethylsilane is used as external reference for the ¹H and ²⁹Si chemical shifts. The temperature is controlled by a variable temperature unit (±0.1 K). The NMR spectra are run at 300° K.

To obtain proton-decoupled silicon-29 NMR spectra, use was made of an accumulation sequence with decoupling of “inverse gated” type of the proton (Waltz 16). The silicon-29 pulse angle is equal to 45° and the time between two silicon pulses is set at 4.5 seconds. The free precession signal (FID) is obtained after 4096 accumulations. The spectral width is 10 870 Hz and the number of points defining the free precession signal is equal to 32 768.

Preparation of Samples

For the samples which require the recording of one-dimensional silicon NMR spectra, approximately 2 ml of silicon compounds are dissolved in 7 ml of a deuterochloroform solution comprising 2.5×10 mol/l of Fe(acac)₃ (acac=acetylacetonate).

¹H NMR and ¹³C NMR

Equipment

Preparation examples: 0.1 ml of sample in 0.5 ml of CDC₁₃ Spectrometer: Bruker AMX 300 Probe: QNP 5 mm (¹H, ¹³C, ³¹P, ¹⁹F) The NMR spectra are run at 300° K. (±0.1° K.).

¹H NMR Analysis

Use was made of a simple acquisition sequence, with a pulse angle of 30°, a time between pulses of 4.6 s, and 256 accumulations. The spectral width is 4500 Hz and no mathematical processing is carried out. The observation frequency is 300 MHz.

¹³C NMR Analysis

Use was made of an accumulation sequence with proton decoupling (Waltz 16), with a pulse angle of 30°, a time between pulses of 3 s, and 8192 accumulations. The spectral width is 20 000 Hz and the signal is processed with an exponential function before the Fourier transform. The observation frequency is 75 MHz.

The deuterated solvent (CDCl₃) is to compensate for possible drifts of the magnetic field and makes it possible to calibrate the spectra with regard to chemical shift.

### EXAMPLE 1

This example describes the preparation of bis(monoethoxydimethylsilylpropyl) tetrasulphide (abbreviated to MESPT) of formula (III) by employing the synthetic method F.

91.9 g of sodium ethoxide (1.352 mol, i.e. the equivalent of 2 mol per one mole of H₂S), as a 21% by mass solution in ethanol (438 g), and 250 ml of toluene are introduced as heel under a stream of argon into a 3-litre jacketed glass reactor which is equipped with a reflux condenser, a mechanical stirrer (Rushton turbine), a thermocouple, a gas (argon or H₂S) admission pipe and an inlet for the peristaltic pump.

Stirring is begun.(200-300 revolutions/minute). A mass of 65 g of sulphur (2.031 mol, i.e. the equivalent of 3 mol per one mole of H₂S) is then added.

After purging the lines with argon, H₂S (23 g, i.e. 0.676 mol) is introduced by bubbling by means of a dip pipe, i.e. for 45 to 60 minutes.

The solution changes from an orange colouring with orange-yellow particles to a particle-free dark-brown colouring.

The mixture is heated at 60° C. for 1 hour under a stream of argon, so as to bring the conversion to anhydrous Na₂S₄ to completion.

The reaction mixture changes from a dark-brown colour to a brown-red colour with brown particles.

The reaction mixture is then cooled using a cooling means (at 10-15° C.) to reach a temperature in the region of 20° C.

A mass of 244 g of γ-chloropropylethoxy-dimethylsilane (1.352 mol, i.e. the equivalent of 2 mol per one mole of H₂S) is added by means of a peristaltic pump (10 ml/min) over 30 minutes.

The reaction mixture is subsequently heated at 75° C.+2° C. for 4h. During the trial, the NaCl precipitates. After heating for 4 hours, the mixture is cooled to ambient temperature (20-25° C.). It adopts an orange colour with yellow particles.

After decanting the reaction mixture, it is filtered through cellulose board under nitrogen pressure in a stainless steel filter. The cake is washed with 2 times 100 ml of toluene. The filtrate, which is brown-red in colour, is evaporated under vacuum (maximum pressure=3-4×10² Pa, maximum temperature=70° C.).

A mass of 280 g of bis(monoethoxydimethyl-silylpropyl) tetrasulphide (0.669 mol) is then obtained in the form of an oil with an orange-yellow colour. Monitoring by ¹H NMR, by ²⁹Si NMR and ¹³C NMR allows it to be confirmed that the structure obtained is in accordance with the formula (III) given in the description of the first subject matter of the invention.

²⁹Si NMR: 16.3 ppm (s, Me₂(OEt)Si).

¹H NMR: 0.0-0.1 ppm (several s, Si (CH₃)₂, 12H), 0.66 ppm (m, SiCH₂, 4H), 1.13 ppm (t, CH₃CH₂O, 6H), 1.75 ppm (m, SiCH₂CH₂, 4H), 2.64 ppm (t, CH₂S₂), 2.8-3.0 ppm (several t, CH₂S_{x≧3}), 3.61 ppm (q, CH₂O, 4H). ¹³C NMR: −1.95-2.2 ppm (several CH₃Si), 15.4-15.6 ppm (several CH₂Si), 18.5 ppm (OCH₃CH₂), 22.5-23.5 ppm (several SiCH₂CH₂), 42.36 ppm (CH₂S₂), 42.08 ppm (CH₂S₃), 42.59 ppm (CH₂S₄), 42.85-43.5 ppm (CH₂S_{x≧5}), 58.2 ppm (OCH₂CH₃).

The mean number of S atoms per molecule of formula (III) is equal to 3.9±0.1 (x=3.9±0.1).

The mean number of S atoms is calculated by the formula given below:

$$x = \frac{[ \frac{percentage by weight of total S}{32} - \frac{percentage by weight of residual elemental S}{32} ]}{[ \frac{\frac{percentage by weight of total Si}{2}}{28} ]}$$

The percentages by weight of total S and of total Si are obtained by elemental analysis by the X-ray fluorescence method. This overall method for quantitatively determining the total S and the total Si involves dissolving the sample in DMF (dimethylformamide) and not in rendering the sample inorganic. The equipment used is an X-ray fluorescence spectrometer with a Philips TW 2400 trade mark, equipped with a rhodium tube. DMSO (dimethyl sulphoxide), dissolved in DMF, is used as standard for quantitatively determining the sulphur; calibration range for S: from 0 to 3000 ppm. To quantitatively determine the silicon, D4 (octamethyltetrasiloxane), dissolved in DMF, is used as standard; calibration range for Si: from 0 to 3000 ppm. The sample is dissolved in DMF, for the measurement, in a proportion of 0.5 g of sample per 40 g of DMF.

The percentage by weight of residual elemental sulphur is quantitatively determined by GPC (Gel Permeation Chromatography):

analytical conditions: columns used: 3 E PLGEL mixed columns with a styrene-divinylbenzene support, the columns being calibrated with respect to polystyrene standards with masses of 100 to 50 000; detector: Shimadzu SPD6A UV, observation wavelength =270 nm; eluent feed pump: Waters pump; injector: VISP 717+; eluent: dichloromethane; flow rate: 1 ml/min; the flow rate internal standard used is toluene (concentration of toluene in the eluent: 2/1000 weight/weight);

standardization: volumes injected: 10 μl for the standard in 20-50 μl for the samples; range of the concentrations used: for the pure elemental sulphur standard used to establish the calibration curve, use is made of 10 to 30 mg of standard in 20 ml of dichloromethane and, for the samples, use is made of 200 mg of sample in 20 ml of dichloromethane;

quantitative determination: the standard and the samples are dissolved in dichloromethane; standard sulphur solutions are injected and a calibration curve relating the surface area of the peak detected and the concentration of elemental sulphur injected is drawn up; under the same conditions, the samples are injected and the concentration of residual elemental sulphur is measured.

For MESPT of formula (III), the following values are found: % by weight of total S=30.1%, % by weight of residual elemental S=0.75%, and % by weight of total Si=13.1%, which, by application of the formula given above, result in the calculated value of x given above and equal to 3.9.

As regards the molar distribution of the polysulphides of MESPT of formula (III), the following values, according to analysis by ¹³C NMR, are found: S₂=16±1.5%, S₃=28±1.5%, S₄=27±1% and S_{≧5}=29±1.5%.

This molar distribution of the polysulphides is obtained in the following way: the ¹³C NMR spectrum is expanded (or magnified) between 41.0 and 44.0 ppm; subsequently, the three peaks at approximately 42 ppm, 42.3 ppm and 42.5 ppm are integrated (I1, I2 and I3 are the values of the respective integrals), along with the unresolved peak situated between 42.7 ppm and 43.7 ppm approximately (for example, unresolved peak ranging from 42.85 to 43.5 ppm) corresponding to the integral I4; then the distribution is calculated:

mol % S₂=(I2×100)/(I1+I2+I3+I4)

mol % S₃=(I1×100) (I1+I2+I3+I4)

mol % S₄=(I3×100)/(I1+I2+I3+I4)

mol % S_{≧5}=(I4×100)/(I1+I2+I3+I4).

It is therefore observed that in accordance with a preferred embodiment of the invention, the molar level of (S₃+S₄) is greater than 50%, the polysulphides S₃ and S₄ thus representing the majority of the polysulphides. Furthermore, the molar level of S₂ is preferably less than 20%.

It will be understood that modified synthetic conditions would make it possible to obtain other molar distributions of the polysulphides, with mean numbers of S atoms per molecule (x) which are variable but always within the ranges from 3±0.1 to 5±0.1, and preferably from 3.5±0.1 to 4.5±0.1.

### EXAMPLE 2

This example describes the preparation of bis(monoethoxydimethylsilylpropyl) disulphide (abbreviated to MESPD) by employing the synthetic method F′.

284.2 g of sodium ethoxide (4.18 mol, i.e. the equivalent of 2 mol per one mole of H₂S), as a 21% by mass solution in ethanol (1353.3 g), are introduced as heel under a stream of argon into a 5-litre jacketed glass reactor which is equipped with a reflux condenser, a mechanical stirrer (Rushton turbine), a thermocouple, a gas (argon or H₂S) admission pipe and an inlet for the peristaltic pump.

Stirring is begun (200-300 revolutions/min). A mass of 66.87 g of sulphur (2.09 mol, i.e. the equivalent of 1 mol per one mole of H₂S) is then added.

After purging the lines with argon, H₂S (71.0 g, i.e. 2.09 mol) is introduced by bubbling using a dip pipe, i.e. for 45 to 60 minutes.

The solution becomes homogeneous and adopts a particle-free chestnut-brown colour.

The mixture is heated at 60° C. for 1 hour under a stream of argon, so as to bring the conversion to anhydrous Na₂S₂ to completion.

A yellow precipitate appears.

The reaction mixture is then cooled using a cooling means (at 10-15° C.) to reach a temperature in the region of 20° C.

A mass of 754.4 g of γ-chloropropylethoxy-dimethylsilane. (4.18 mol, i.e. the equivalent. of 2 mol per one mole of H₂S) is added using a peristaltic pump (10 ml/min). over 30 minutes.

The reaction mixture is subsequently heated at 70° C. for 4h. During the trial, NaCl precipitates. After heating for 4 hours, the mixture is cooled to ambient temperature (20-25° C.). It adopts a green colour with yellow particles.

After decanting the reaction mixture, it is filtered through cellulose board under nitrogen pressure in a stainless steel filter. The filtrate, which is orange in colour, is evaporated under vacuum (maximum pressure=5×10² Pa, maximum temperature=40° C.).

A mass of 739.74 g of bis(monoethoxydimethyl-silylpropyl) disulphide (2.089 mol) is then obtained in the form of an oil which is khaki in colour. Monitoring by ¹H NMR and by ²⁹Si NMR makes it possible to confirm that the structure obtained is in accordance with the formula:

(C₂H₅O)(CH₃)₂Si—(CH₂)₃—S_{y}—(CH₂)₃—Si(CH₃)₂ (OC₂H₅)

²⁹Si NMR: 16.5 ppm (s, Me₂(OEt)Si).

¹H NMR: 0.03 ppm (s, Si(CH₃)₂, 12H), 0.61 ppm (m, SiCH₂, 4H), 1.11 ppm (t, CH₃CH₂O, 6H), 1.65 ppm (m, SiCH₂CH₂, 4H), 2.62 ppm (t, CH₂S₂), 2.80 ppm (t, CH₂S₃), 3.58 ppm (q, CH₂O, 4H).

¹³C NMR: −1.8,-−2.5 ppm, (several CH₃Si), 15.1 ppm (CH₂Si), 18.5 ppm (CH₃CH₂O), 22.8.-23.2 ppm (several SiCH₂CH₂), 42.4 ppm (CH₂S₂), 42.1 ppm (CH₂S₃), 58.2 ppm (OCH₂CH₃).

The mean number of S atoms per molecule of MESPD, calculated as indicated above in Example 1, is equal to 1.9 (% by weight of total S=15.7%, % by weight of residual elemental S=0% and % by weight of total Si=14.4%).. In view of the calculated value of y, equal to 1.9, and of the standard deviation under consideration (±0.1), it results therefrom that the true value of y is close to or equal to 2.

As regards the molar distribution of the polysulphides of MESPD, the following values, according to ¹³C NMR analysis are found: S₂=94% and S₃=6%.

This molar distribution of the polysulphides is obtained in the following way: the ¹³C. NMR spectrum is expanded (or magnified) between 41.0 and 44.0 ppm; subsequently, the two peaks at 42.1 ppm and 42.4 ppm are integrated (Ii and I2 are the values of the integrals respectively); then the distribution is calculated:

mol % S₂(I2×100)(I1+I2)

mol % S₃=(I1×100)/(I1+I2).

### EXAMPLE 3 AND TESTS 1 TO 4

The aim of this example and of these tests is to demonstrate the improved coupling performance of a tetrasulphide monoorganoxysilane of formula (I) according to the invention; this performance is compared, on the one hand, with that of coupling agents based on disulphide silanes, one comprising three organoxysilyl functional groups (TESPD silane) and the other comprising a single organoxysilyl functional group (MESPD silane), and, on the other hand, with that of a coupling agent based on the tetrasulphide silane comprising three organoxysilyl functional groups (TESPT silane).

5 diene elastomer compositions representative of shoe sole formulations are compared. These 5 compositions are identical, apart from the following differences:

composition No. 1 (control 1): coupling agent based on TESPD silane (5.8 pce or parts by weight per 100 parts of elastomers) used alone; it should be remembered that:

TESPD: bis(triethoxysilylpropyl) disulphide of formula:

(C₂H₅O)₃Si—(CH₂)₃—S₂—(CH₂)₃—Si(OC₂H₅)₃

composition No. 2 (control 2): coupling agent based on MESPD silane (4.3 pce) used alone; it should be remembered that:

MESPD: bis(monoethoxydimethylsilylpropyl) disulphide of formula:

(C₂H₅O)(CH₃)₂Si—(CH₂)₃—S₂—(CH₂)₃—Si(CH₃)₂ (OC₂H₅)

composition No. 3 (control 3): coupling agent based on TESPT silane (6.6 pce) used alone; it should be remembered that:

TESPT: bis(triethoxysilylpropyl) tetrasulphide of formula:

(C₂H₅O)₃Si—(CH₂)₃—S₄—(CH₂)₃—Si (OC₂H₅)₃

composition No. 4 (control 4): MESPD (4.3 pce), with which is associated 0.8 pce of sulphur;

composition No. 5 (Example 3): coupling agent based on bis(monoethoxydimethylsilylpropyl) tetrasulphide or MESPT (5.1 pce) of formula:

(C₂H₅O)(CH₃)₂Si—(CH₂)₃—S₄—(CH₂)₃—Si(CH₃)₂ (OC₂H₅)

The coupling agents are used here at an isomolar silicon level, that is to say that, whatever the composition, the same number of ethoxysilyl groups with respect to the silica and its surface hydroxyl groups is used.

1) Makeup of the Compositions:

The following compositions are prepared in an internal mixer of Brabender type, the levels of the various constituents in which compositions, expressed in pce (parts by weight per 100 parts of elastomers),, are shown in Table I given below.

TABLE I

| | Control | Control | Control | | |
|---|---|---|---|---|---|
| Compositions | 1 | 2 | 3 | Control 4 | Ex. 3 |
| SBR Rubber (1) | 96 | 96 | 96 | 96 | 96 |
| BR Rubber (2) | 30 | 30 | 30 | 30 | 30 |
| Silica (3) | 80 | 80 | 80 | 80 | 80 |
| Zinc oxide (4) | 3.0 | 3.0 | 3.0 | 3.0 | 3.0 |
| Stearic acid (5) | 2.0 | 2.0 | 2.0 | 2.0 | 2.0 |
| Microcrystalline wax (6) | 1.0 | 1.0 | 1.0 | 1.0 | 1.0 |
| Plasticizer (7) | 10 | 10 | 10 | 10 | 10 |
| Permanax 6 PPD (8) | 1.5 | 1.5 | 1.5 | 1.5 | 1.5 |
| TESPD Silane (9) | 5.8 | — | — | — | — |
| MESPD Silane (10) | — | 4.3 | — | 4.3 | — |
| TESPT Silane (11) | — | — | 6.6 | — | — |
| MESPT Silane (12) | — | — | — | — | 5.1 |
| CBS (13) | 1.5 | 1.5 | 1.5 | 1.5 | 1.5 |
| DPG (14) | 2.0 | 2.0 | 2.0 | 2.0 | 2.0 |
| TBZTD (15) | 0.2 | 0.2 | 0.2 | 0.2 | 0.2 |
| Sulphur (16) | 1.5 | 1.5 | 1.5 | 2.3 | 1.5 |

(1) Styrene-butadiene copolymer as a solution comprising 37.5 pce of oil, sold by Bayer under the reference S-SBR 5525-1;
(2) Polybutadiene with a high level of cis-1,4 form, sold by Kumho under the reference Kosyn KBR 01;
(3) Highly dispersible silica Zeosil 1165 MP, sold by Rhodia Silices;
(4) and (5) Vulcanization activators;
(6) Processing aid, which is a wax sold by La Ceresine under the Cerelux ® 120 trademark;
(7) Naphthenic oil, sold by Nynas under the name Nytex 820;
(8) Antizone protector based on N-phenyl-N′-(1,3-dimethylbutyl)-paraphenylenediamine, sold by Akzo Chemicals;
(9) Silane sold by Witco under the name Silquest A1589 (y in the region of 2);
(10) Silane prepared as indicated in Example 2;
(11) Silane sold by Witco under the name Silquest A1289 (y in the region of 4);
(12) Silane prepared as indicated in Example 1;
(13) Vulcanization accelerator based on N-cyclohexyl-2-benzothiazylsulphenamide;
(14) Vulcanization accelerator based on diphenylguanidine;
(15) Vulcanization accelerator based on tetrabenzylthiuram disulphide, sold by Flexsys;
(16) Vulcanization agent added on multi-roll mixer.

2) Preparation of the Compositions:

Each composition is prepared in the following way:

The following phases 1 and 2 are carried out in an internal mixer of Brabender type rotating at 100 revolutions/minute, the various constituents being introduced in the order, at the times and at the temperatures indicated below:

| | | |
|---|---|---|
| Time | Temperature | Constituents |

Phase 1:

| | | |
|---|---|---|
| t0 | 80° C. | SBR and BR rubbers |
| t0 + 1.5 min | 100° C. | 1/3 silica + coupling |
| | | agent + plasticizer |
| t0 + 2.5 min | 120° C. | 2/3 silica + stearic acid + microcrystalline |
| | | wax |
| t0 + 5 min | 150° C. | Emptying of the mixer |

Phase 2:

| | | |
|---|---|---|
| t0 | 80° C. | Charging of the blend |
| | | resulting from phase 1 |
| t0 + 0.5 min | 110° C. | Zinc oxide + protector 6 |
| | | PPD |
| t0 + 3 min | 140° C. | Emptying of the mixer |

The blend obtained on conclusion of phase 2 is subsequently introduced onto a multi-roll mixer maintained at 60° C. and the sulphur, CBS, DPG and TBZTD are introduced. After homogenizing for 2 minutes, the final blend is calendered in the form of sheets with a thickness of 2.5 to 3 mm.

3) Rheological Properties of the Compositions:

The measurements are carried out on the compositions in the raw state. The results of the rheology test, which is carried out at 165° C. for 30 minutes using a Monsanto 100 S rheometer, have been shown in the following Table II.

According to this test, the test composition is placed in the test chamber adjusted to a temperature of 165° C. and the resistive torque opposed by the composition to a low-amplitude oscillation of a biconical rotor included in the test chamber is measured, the composition completely filling the chamber under consideration. The following are determined from the curve of variation of the torque as a function of time: the minimum torque, which reflects the viscosity of the composition at the temperature under consideration; the maximum torque and the delta torque, which reflect the degree of crosslinking caused by the action of the vulcanization system; the time T-90 necessary to obtain a vulcanization state corresponding to 90% of complete vulcanization (this time is taken as vulcanization optimum).; and the scorch time TS-2, corresponding to the time necessary in order to have a rise of 2 points above the minimum torque at the temperature under consideration (165° C.) and which reflects the time during which it is possible to process the raw blends at this temperature without having initiation of vulcanization.

The results obtained are shown in Table II.

TABLE II

| Monsanto | | | | | |
|---|---|---|---|---|---|
| rheology | Control 1 | Control 2 | Control 3 | Control 4 | Example 3 |
| Minimum | 14.3 | 13.5 | 13.1 | 13.1 | 12.8 |
| torque | | | | | |
| Maximum | 59.3 | 59.4 | 68.7 | 67.3 | 68 |
| torque | | | | | |
| Delta | 45 | 45.9 | 55.6 | 54.2 | 55.2 |
| torque | | | | | |
| TS-2 | 4.28 | 4.73 | 3.23 | 3.65 | 3.23 |
| (minutes) | | | | | |
| T-90 | 7.41 | 6.87 | 7.38 | 5.48 | 5.79 |
| (minutes) | | | | | |

It is found that, whatever the sulphur-comprising part of the silane under consideration (di- or tetrasulphide), the change from a triethoxyl silane to a monoethoxyl silane leads to a significant acceleration in the rate of vulcanization, which is reflected by the achievement of a shorter time T-90 during the Monsanto test (compare Controls 1 and 2, on the one hand, and Control 3 and Example 3, on the other hand).

If all the rheological properties are considered, it may be observed that, of all the silanes tested, the tetrasulphide monoethoxyl silane (Example 3) introduces the best compromise in properties, with a lower minimum torque, a high delta torque and fast kinetics of vulcanization.

4) Mechanical Properties of the Vulcanizates:

The measurements are carried out on compositions uniformly vulcanized for 30 minutes at 165° C.

The properties measured and the results obtained are collated in the following Table III:

TABLE III

| | Control | Control | Control | Control | |
|---|---|---|---|---|---|
| Mechanical properties | 1 | 2 | 3 | 4 | Example 3 |
| 10% modulus (1) | 0.69 | 0.55 | 0.76 | 0.69 | 0.66 |
| 100% modulus (1) | 1.96 | 1.85 | 2.51 | 2.55 | 2.55 |
| 300% modulus (1) | 8.8 | 8.0 | 11.2 | 11.7 | 11.2 |
| Elongation at break (1) | 480 | 500 | 415 | 380 | 450 |
| Tensile strength (1) | 17.5 | 17.0 | 17.3 | 16 | 18.4 |
| Reinforcement indices: | | | | | |
| 300% M/100% M | 4.49 | 4.38 | 4.46 | 4.6 | 4.39 |
| Shore A hardness (2) | 64 | 63 | 68 | 64 | 68 |

(1) The tensile tests are Carried out in accordance with the instructions of Standard NF T 46-002 with test specimens of H2 type. The 10% and 300% moduli and the tensile strength are expressed in MPa; the elongation at break is expressed as %.
(2) The measurement is carried out according to the instructions of Standard ASTM D 3240. The value given is measured at 15 seconds.

Examination of the various results leads to the following observations:

it is found, in the case of disulphide coupling agents (Controls 1 and 2), that the change from the triethoxyl silane (Control 1) to the monoethoxyl silane (Control 2) leads, with regard to the vulcanizates, to significant weakening in some of the mechanical properties: thus, for the following properties, the decreases (expressed as %) in values indicated below are recorded: 100% modulus: change from 1.96 to 1.85, i.e. a decrease of −5.6%; 300% modulus; change from 8.8 to 8.1, i.e. a decrease of −7.9%; reinforcement index: change from 4.49 to 4.38, i.e. a decrease of −2.4%; the tensile strength (change from 17.5 to 17.0, i.e. a decrease of −2.9%) and the Shore A hardness (change from 64 to 63, i.e. a decrease of −1.6%) are weakened but to a lesser degree;

it is found, in the case of tetrasulphide coupling agents (Control 3 and Example 3), that the change from the triethoxyl silane (Control 3) to the monoethoxyl silane (Example 3) does not, with regard to the vulcanizates, lead to similar weakenings for the mechanical properties considered above; the latter have their values which are either less weakened (cf. reinforcement index, where a fall of only −1.6% is recorded) or maintained (cf. 300% modulus and Shore A hardness) or improved (cf. tensile strength, where an increase of +6.4% is recorded);

for the monoethoxyl and tetrasulphide silane (Example 3), in addition to the compromise in the rheological properties already emphasized, a more advantageous compromise in mechanical properties than that obtained for the monoethoxyl and disulphide silane (Control 2) is also observed; thus, the following are recorded for the vulcanizate of Example 3: the levels of properties which are increased by.+20% for the 10% modulus, by +37.8% for the 100% modulus, by +38.3% for the 300% modulus, by +8.2% for the tensile strength and by +7.9% for the Shore A hardness;

such differences (hardness, moduli, tensile strength) can be attributed to the higher content of sulphur in the tetrasulphide silanes with respect to the disulphide silanes in general (compare also Controls 1 and 3).

We have therefore added sulphur to the multi-roll mixer (cf. Control Blend 4) in order to compensate for the difference in sulphur content between the two monoethoxyl silanes (Control 2 and Example 3) and in order to confirm whether it was thus possible to rediscover the levels of properties obtained with the. tetrasulphide silane of Example 3. The comparison between Control 4 (with monoethoxyl and disulphide silane with compensated sulphur on a multi-roll mixer) and Example 3 (monoethoxyl and tetrasulphide silane) leads to the following other observations:

it is found that the supplementation of sulphur makes it possible to increase the maximum torque sand the delta torque of the raw blends, thus placing Control 4 and Example 3 at comparable levels,

likewise with regard to the mechanical properties of the vulcanisates, the moduli of Control 4 are raised to the level of those of Example 3,

in contrast, a very substantial weakening of the final properties and in particular of the elongation at break (−15.6%) and of the tensile strength (−13%) of the vulcanizates is observed,

furthermore, surprisingly, the Shore hardness, in contrast to the moduli, is not affected to any great extent with respect to Control 2 by the supplementation with sulphur and does not reach the level of Example 3.

The supplementary addition of sulphur to rolls in the composition comprising the monoethoxyl and disulphide silane (Control 2) therefore did not make it possible to rediscover the excellent compromising properties introduced by the monoethoxyl and tetrasulphide silane (Example 3), since the final properties are substantially affected by this supplementary addition of sulphur (Control 4).

1. Polysulphide monoorganoxysilanes with a propylene linking unit of formula: 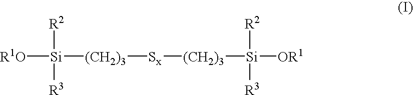
in which:
the R¹ symbols, which are identical or different, each represent a monovalent hydrocarbonaceous group chosen from a linear or branched alkyl radical having from 1 to 4 carbon atoms and a linear or branched alkoxyalkyl radical having from 2 to 8 carbon atoms;
the R² and R³ symbols, which are identical or different, each represent a monovalent hydrocarbonaceous group chosen from a linear or branched alkyl radical having from 1 to 6 carbon atoms and a phenyl radical; and
x is an integer or fractional number ranging from 3±0.1 to 5±0.1.

2. Polysulphide monoorganoxysilanes according to claim 1, characterized in that, in the formula (I):
the R¹ radicals are chosen from the following radicals: methyl, ethyl, n-propyl, isopropyl, n-butyl, CH₃OCH₂—, CH₃OCH₂CH₂— and CH₃OCH (CH₃) CH₂—;
the R² and R³ radicals are chosen from the following radicals: methyl, ethyl, n-propyl, isopropyl, n-butyl, n-hexyl and phenyl;
the integer or fractional number x ranges from 3.5±0.1 to 4.5±0.1.

3. Polysulphide monoorganoxysilanes according to claims 1 and 2, characterized in that these are those of formulae: 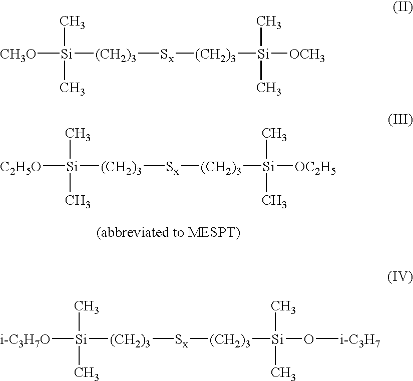
in which the x symbol is an integer or fractional number ranging from 3. 0.1 to 5±0.1 and preferably from 3.5±0.1 to 4.5±0.1.

4. Polysulphide monoorganoxysilanes according to any one of claims 1 to 3, characterized in that they are composed of a distribution of polysulphides comprising a molar level: of (S₃+S₄), equal to or greater than 40% and preferably equal to or greater than 50%; and of (S₂+S>5), equal to or less than 60% and preferably equal to or less than 50%.

5. Process for the preparation of the polysulphide monoorganoxysilanes according to any one of claims 1 to 4, characterized in that the compounds of formula (I), (II), (III) or (IV) can be obtained by direct reaction of a halogenated monoorganoxysilane of formula (V) with an anhydrous metal polysulphide of formula (VI), the reaction being carried out at a temperature ranging from −20° C. to 90° C., optionally in the presence of an inert polar (or nonpolar) organic solvent, by applying the following synthetic scheme: 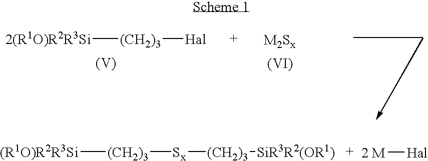
where:
the R¹, R², R³ and x symbols are as defined above in claim 1, 2, 3 or 4;
the Hal symbol represents a halogen atom chosen from the chlorine, bromine and iodine atoms;
the M symbol represents an alkali metal or alkaline earth metal.

6. Process for the preparation of the polysulphide monoorganoxysilanes according to any one of claims 1 to 4, characterized in that the compounds of formula (I), (II), (III) or (IV) can be obtained by direct reaction of elemental sulphur with a monoorganoxysilanethiol of formula (VII), the reaction being carried out at a temperature ranging from 10° C. to 250° C., optionally in the presence of an inert polar (or nonpolar) organic solvent, by applying the following synthetic scheme: 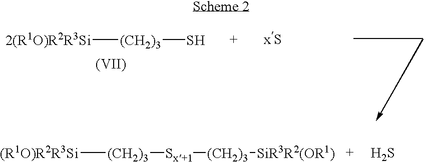
where:
the R¹, R² and R³ symbols are as defined above in claim 1, 2, 3 or 4;
x′ is an integer or fractional number ranging from 2±0.1 to 4±0.1 and preferably from 2.5±0.1 to 3.5±0.1.

7. Process for the preparation of the polysulphide monoorganoxysilanes according to any one of claims 1 to 4, characterized in that the compounds of formula (I), (II), (III) or (IV) can also be obtained by direct reaction of elemental sulphur and of an alkali metal M′ with a halogenated silane of formula (V), the reaction being carried out at a temperature ranging from 60° C. to 100° C., optionally in the presence of an aprotic organic solvent, by applying the following synthetic scheme: 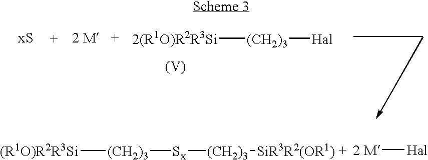
where:
the R¹, R², R³, x and Hal symbols are as defined above in claim 5;
the M′ symbol represents an alkali metal.

8. Process for the preparation of the polysulphide monoorganoxysilanes according to any one of claims 1 to 4, characterized in that the compounds of formula (I), (II), (III) or (IV) can be obtained by carrying out the following stages (a) and (b):
(a) H₂S is brought into contact with a metal alkoxide of formula (VIII), employed in the solution form, the reaction being carried out at a temperature ranging from 25° C. to 60° C., optionally in the presence of an inert polar (or nonpolar) organic solvent, by applying the following synthetic scheme: 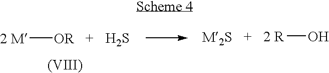
where M′ is as defined above in claim 7 and R represents a linear or branched alkyl radical having from 1 to 4 carbon atoms; then
(b) a mixture based on elemental sulphur and on halogenated monoorganoxysilane of formula (V) is reacted with the reaction product from stage (a), the reaction being carried out at a temperature ranging from 25° C. to the reflux temperature of the reaction medium.

9. Process for the preparation of the polysulphide monoorganoxysilanes according to any one of claims 1 to 4, characterized in that the compounds of formula (I), (II), (III) or (IV) can be obtained by carrying out stages (c) and (d) defined below:
(c) ammonia NH₃ or an amine is brought into contact, at ambient temperature of the order of 25° C., with H₂S and elemental sulphur; then
(d) the halogenated silane of formula (V) defined above in claim 5 is reacted with the reaction product from stage (c), the reaction being carried out under autogenous pressure at a temperature ranging from 0° C. to 175° C., optionally in the presence of an inert polar (or nonpolar) organic solvent, by applying the following synthetic scheme: 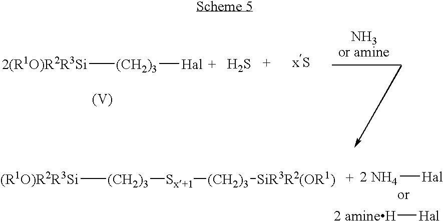
where the various R¹, R², R³, Hal and x′ symbols are as defined above in claims 5 and 6 (for the x′ symbol).

10. Process for the preparation of the polysulphide monoorganoxysilanes according to any one of claims 1 to 4, characterized in that the compounds of formula (I), (II), (III) or (IV) can be obtained by carrying out-stages (e) and (f) defined below:
(e) a metal alkoxide of formula (VIII) defined above in claim 8, employed in the solution form, is brought into contact, at a temperature ranging from 25° C. to 80° C., optionally in the presence of an inert polar (or nonpolar) organic solvent, with, in a first step, elemental sulphur and, in a second step, H₂S; then
(f) the halogenated silane of formula (V) defined above in claim 5 is reacted with the reaction product from stage (e), the reaction being carried out at a temperature ranging from 40° C. to 100° C., optionally under autogenous pressure, optionally in the presence of an inert polar (or nonpolar) organic solvent;
by applying the following synthetic scheme: 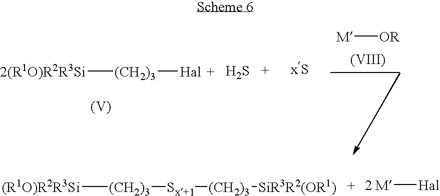
where the various R¹, R², R³, Hal, x′, M′ and R symbols are as defined above in claims 5 and 6 (for x′) and 8 (for M′ and R).

11. Process for the preparation of polysulphide silanes of formula:
(R¹O)ₐ(R²)_{b}(R³)_{c}Si—R⁴—S_{y}—R⁴—Si(R³)_{c}(R²)_{b}(OR¹)ₐ (XII)
in which:
the R¹, R² and R³ symbols are as defined above in claim 1, 2 or 3;
the a, b and c symbols each.represent an integer ranging from 0 to 3, the sum a+b+c having to be equal to 3;
the R⁴ symbols, which are identical or different, each represent a divalent radical chosen from: a linear or branched divalent alkylene radical having from 1 to 18 carbon atoms; an -alkylene-cycloalkylene-radical where the alkylene part is as defined immediately above and where the cyclic part comprises 5 to 10 carbon atoms and is optionally substituted by one or two linear or branched alkyl radicals having from 1 to 3 carbon atoms; a divalent -alkylene-phenylene-(alkylene)_{z}- radical where z=0 or 1, where the alkylene part(s) is (are) as defined immediately above and where the phenylene part is optionally substituted by one or two linear or branched alkyl radicals having from 1 to 3 carbon atoms;
the y symbol represents an integer or fractional number ranging from 2±0.1 to 10±0.1;
it being clearly understood that the polysulphide organoxysilanes corresponding to the formula (I), that is to say the polysulphide silanes of formula (XII) where cumulatively a=b=c=1, R⁴=—(CH₂)₃— and y is a number ranging from 3±0.1 to 5±0.1, are excluded from the formula (XII);
the said process being characterized in that stages (e′) and (f′) defined below are carried out:
(e′) a metal alkoxide of formula (VIII) defined above in claim 8, employed in the solution form, is brought into contact, at a temperature ranging from 25° C. to 80° C., optionally in the presence of an inert polar (or nonpolar) organic solvent, with, in a first step, elemental sulphur and, in a second step, H₂S; then
(f′) the halogenated silane of formula (XIII) is reacted with the reaction product from stage (e′), the reaction being carried out at a temperature ranging from 40° C. to 100° C., optionally under autogenous pressure, optionally in the presence of an inert polar (or nonpolar) organic solvent;
by applying the following synthetic scheme: 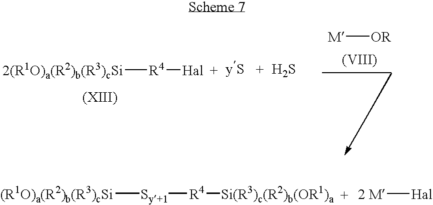
where:
the R¹, R², R³, R⁴, a, b and c symbols are as defined above in the formula (XII);
the Hal symbol is as defined above in claim 5; [lacuna]
the y′ symbol is an integer or fractional number ranging from 1 to 9.

12. Use of an effective amount of at least one polysulphide monoorganoxysilane with a propylene linking unit of formula (I), (II), (III) or (IV) according to any one of claims 1 to 4 as white filler-elastomer coupling agent in compositions comprising at least one diene elastomer and one white filler as reinforcing filler, the said compositions being intended for the manufacture of articles made of diene elastomer(s).

13. Diene elastomer composition comprising a reinforcing white filler obtained by virtue of the use of an effective amount of at least one polysulphide monoorganoxysilane with a propylene linking unit of formula (I), (II), (III) or (IV) according to any one of claims 1 to 4.

14. Compositions according to claim 13, characterized in that they comprise (the parts are given by weight):
per 100 parts of diene elastomer(s),
10 to 200 parts of reinforcing white filler, and
1 to 20 parts of coupling agent(s).

15. Compositions according to claim 14, characterized in that they comprise:
per 100 parts of diene elastomer(s),
20 to 150 parts of reinforcing white filler, and
2 to 20 parts of coupling agent(s).

16. Compositions according to any one of claims 13 to 15, characterized in that the reinforcing white filler is composed of silica, alumina or a mixture of these two entities.

17. Compositions according to claim 16, characterized in that:
the silica is a conventional or highly dispersible precipitated silica exhibiting in particular a BET specific surface area ≦450 m²/g;
the alumina is a highly dispersible alumina exhibiting in particular a BET specific surface area ranging from 30 to 400 m²/g and a high level of reactive surface Al—OH functional group.

18. Compositions according to any one of claims 13 to 17, characterized in that the diene elastomer(s) is (are) chosen from:
(1) homopolymers obtained by polymerization of a conjugated diene monomer having from 4 to 22 carbon atoms, such as, for example: 1,3-butadiene, 2-methyl-1,3-butadiene, 2,3-dimethyl-1,3-butadiene, 2,3-diethyl-1,3-butadiene, 2-methyl-3-ethyl-1,3-butadiene, 2-chloro-1,3-butadiene, 2-methyl-3-isopropyl-1,3-butadiene, 1-phenyl-1,3-butadiene, 1,3-pentadiene or 2,4-hexadiene;
(2) copolymers obtained by copolymerization of at least two of the abovementioned conjugated dienes with one another or by copolymerization of one or more of the abovementioned conjugated dienes with one or more ethylenically unsaturated monomers chosen from:
vinylaromatic monomers having from 8 to 20 carbon atoms, such as, for example: styrene, ortho-, meta- or para-methylstyrene, the “vinyl-toluene” commercial mixture, para-tert-butylstyrene, methoxystyrenes, chlorostyrenes, vinylmesitylene, divinylbenzene or vinylnaphthalene;
vinyl nitrile monomers having from 3 to 12 carbon atoms, such as, for example, acrylonitrile or methacrylonitrile;
acrylic ester monomers derived from acrylic acid or from methacrylic acid with alkanols having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate;
the copolymers can comprise between 99% and 20% by weight of diene units and between 1% and 80% by weight of vinylaromatic, vinyl nitrile and/or acrylic ester units;
(3) ternary copolymers obtained by copolymerization of ethylene and of an α-olefin having 3 to 6 carbon atoms with a nonconjugated diene monomer having from 6 to 12 carbon atoms;
(4) natural rubber;
(5) copolymers obtained by copolymerization of isobutene and of isoprene (butyl rubber), and the halogenated, in particular chlorinated or brominated, versions of these copolymers;
(6) a blend of several of the abovementioned elastomers (1) to (5) with one another.

19. Compositions according to claim 18, characterized in that recourse is had to one or more elastomer(s) chosen from: (1) polybutadiene, polychloroprene or polyisoprene [or poly(2-methyl-1,3-butadiene)]; (2) poly(isoprene-butadiene), poly(isoprene-styrene), poly(isoprene-butadiene-styrene), poly(butadiene-styrene) or poly(butadiene-acrylonitrile); (4) natural rubber; (5) butyl rubber; (6) a blend of the abovementioned elastomers, in particular (1), (2), (4), (5), with one another; (6′) a blend comprising a predominant amount (ranging from 51% to 99.5% and preferably from 70% to 99% by weight) of polyisoprene (1) and/or of natural rubber (4) and a minor amount (ranging from 49% to 0.5% and preferably from 30% to 1% by weight), of polybutadiene, of polychloroprene, of poly(butadiene-styrene) and/or of poly(butadiene-acrylonitrile).

20. Compositions according to any one of claims 13 to 19, characterized in that they additionally comprise all or some of the other auxiliary additives and constituents conventionally used in the field of elastomer and rubber compositions, the said other additives and constituents comprising:
as regards the vulcanization system:
vulcanization agents chosen from sulphur or sulphur-donating compounds;
vulcanization accelerators;
vulcanization activators;
as regards other additive(s):
a conventional reinforcing filler composed of carbon black;
a conventional white filler with little or no reinforcing effect;
antioxidants;
antiozonants;
plasticizing agents and processing aids.

21. Process for the preparation of the diene elastomer compositions according to any one of claims 13 to 20, characterized in that:
all the necessary constituents, with the exclusion of the vulcanization agent(s) and optionally of the vulcanization accelerator(s) and/or of the vulcanization activator(s), are introduced into and mixed in a conventional internal mixer, in one or two stages, the operation being carried out at a temperature ranging from 80° C. to 200° C.;
the blend thus obtained is then subsequently taken up on an external mixer and then the vulcanization agent(s) and optionally the vulcanization accelerator(s) and/or the vulcanization activator(s) are added thereto, the operation being carried out at a lower temperature, below 120° C.

22. Articles made of elastomer(s), characterized in that they have a body comprising a composition according to any one of claims 13 to 20.

23. Articles according to claim 22, characterized in that they are composed of engine supports, shoe soles, cableway rollers, seals for domestic electrical appliances, and cable sheathings.
